(19) United States
(12) Patent Application Publication
(10) Pub. No.: US 2020/0218019 A1
(43) Pub. Date: Jul. 9, 2020

(54) COMPOSITE RIBBON CABLE HAVING CARBON NANOTUBE YARNS AND OPTICAL FIBRES

(71) Applicant: PRYSMIAN S.p.A., Milano (IT)

(72) Inventors: Luca Giorgio Maria DE RAI, Milano (IT); Ehsan FALLAHMOHAMMADI, Columbia, SC (US); Donald Ray PARRIS, Milano (IT)

(21) Appl. No.: 16/738,998

(22) Filed: Jan. 9, 2020

(30) Foreign Application Priority Data
Jan. 9, 2019 (IT) 102019000000253

(51) Int. Cl. G02B 6/44; C01B 32/158; B82Y 30/00; B82Y 40/00

(52) U.S. Cl. CPC G02B 6/4403; C01B 32/158; C01B 2202/02; B82Y 40/00; C01B 2202/36; B82Y 30/00

(57) ABSTRACT

A cable that includes a telecommunication section including at least one optical fiber; at least two electric sections each including at least one bundle of carbon nanotube yarns; and a matrix embedding the telecommunication section and the at least two electric sections. The telecommunication section is arranged in the matrix between two electric sections. The optical fiber and the bundles of carbon nanotube yarns are co-planar to form a ribbon.

### BACKGROUND

### Technical Field

The present disclosure relates to the field of cables for communications. Particularly, the present disclosure relates to a composite ribbon cable.

### Description of the Related Art

Nowadays (and, foreseeably, more and more in the future) huge volume of data, along with electric power delivery, is needed in every field, and the demand is quickly growing in the transport (automotive) sector too.

The challenge not only concerns the amount of data to be transmitted, but also the bit-rate of transmission (transmission bandwidth), the dimension (size) and the weight of the cables used for data transmission, which should fit the dimension and structure of the vehicles where the cables are installed.

### BRIEF SUMMARY

The Applicant observes that a cable structure having a round cross-section, which facilitates installation with a cable blowing technique, is not the best choice in many applications, like in the automotive field.

Also, a cable of a round cross-section requires the conductors to be stranded so that the cable is uniformly flexible to avoid undue stress to the conductors while bending. The conductor stranding requires an additional step and apparatus in the manufacturing process. In the case that the cable contains carbon nanotube wires, the carbon nanotube wires carrying positive and negative electric potentials can touch each other, which causes short-circuit.

The Applicant has obtained a cable meeting all the aforementioned requirements without compromising the performance.

The Applicant has conceived and reduced to practice that arranging optical fibers and carbon nanotube (CNT) yarns in a ribbon cable achieves a profitable combination of high transmission bandwidth, compact size and light weight with a structure, e.g., that of an essentially flat ribbon, that is particularly suitable for installation and routing in vehicles.

According to aspects thereof, the present disclosure is directed to a cable comprising:
a telecommunication section comprising at least one optical fiber;
at least two electric sections each comprising at least one bundle of carbon nanotube yarns; and
a matrix embedding the telecommunication section and the at least two electric sections,
wherein the telecommunication section is arranged in the matrix in between two electric sections and the optical fiber and the bundles of carbon nanotube yarns are co-planar to form a ribbon.

In some embodiments, in the cable of the present description the telecommunication section may include two optical fibers.

In some embodiments, the cable of the present description comprises at least two telecommunication sections.

In some embodiments, in the cable of the present description each electric section comprises two bundles of carbon nanotube yarns.

In some embodiments of the present description, each telecommunication section is arranged in the matrix in between two respective electric sections. Accordingly, the cable comprises an even number of electric sections.

In the cable of some embodiments each electric section is intended for carrying a positive or negative electric potential only.

According to some embodiments, each optical fiber and each bundle of carbon nanotube yarns of the cable of the present description have outer diameters substantially similar to one another.

In the cable of the present description, the optical fibers can be single-mode optical fibers, multi-mode optical fibers or a combination thereof.

According to some embodiments of the present description, each bundle of carbon nanotube yarns includes a group of carbon nanotube yarns covered by a coating layer. For example, the coating layer can be 5-10 μm thick.

In some embodiments, the coating layer of each bundle of carbon nanotube yarns is made of a radiation cured material, such as an acrylate. In some embodiments, the acrylate material of the coating layer is a radiation cured material having a modulus of 50-100 MPa and an elongation at break of 100-120%.

In some embodiments, the carbon nanotubes in the yarns of the present disclosure are of single-wall (SWNTs) or of the few-wall type (FWNTs).

In some embodiments, the matrix of the cable of the present disclosure is made of a radiation cured material, such as an acrylate.

According to some embodiments, the acrylate material of the cable matrix is different from the acrylate material of the bundle of carbon nanotube yarns.

According to some aspects, the present disclosure is directed to a process for producing a cable, comprising:
providing a telecommunication section including at least one optical fiber;
providing at least two groups of carbon nanotube yarns; providing each group of carbon nanotube yarns with a respective coating layer to form a bundle; and
embedding in a matrix the telecommunication section and at least two electric sections, each comprising at least one bundle of carbon nanotube yarns,
wherein said embedding in a matrix comprises arranging the telecommunication section in between the two electric sections and arranging the optical fiber and the bundles of carbon nanotube yarns co-planarly to form a ribbon.

The cable according to the present disclosure is advantageous because the ribbon, and thus, the relatively flat nature thereof, is particularly suitable for installations where the space is limited. For example, in the automotive field, the ribbon cable can be easily routed through a vehicle under the upholstery.

The bundles of carbon nanotube yarns of the electric sections allow a suitable electrical current transport while acting as tensile strength members for the ribbon cable, too. The carbon nanotube yarns make the ribbon cable more resistant to tensile stresses. With respect to a copper electrical conductor, the carbon nanotube yarns make the ribbon more flexible. Moreover, carbon nanotube yarns are lighter than metal, e.g., copper, conductors, thus allowing a reduction in weight of the cable.

In the cable according to the present disclosure, each electric section is electrically insulated from the other(s) by the interposition of a telecommunication section.

The cable according to the present disclosure is also advantageous because the same, or quite similar, manufacturing apparatuses and installation (e.g., optical fiber splicing) tools generally used for purely optical ribbon cables can be employed for the present cable.

The summary provided in this section of the present document is to provide an understanding of some aspects of the disclosure. As will be appreciated, other embodiments of the disclosure are possibly utilizing, alone or in combination, one or more of the features set forth above or described in detail below.

### BRIEF DESCRIPTION OF THE SEVERAL VIEWS OF THE DRAWINGS

The features mentioned above, as well as other features and advantages, will be made apparent by the following detailed description of exemplary and non-limiting embodiments of cables according to the present disclosure. While reading the following detailed description, reference should be made to the annexed drawings, wherein:

FIG. 1 schematically depicts a cable according to some embodiments of the present disclosure; and

FIG. 2 schematically depicts a cable according to some embodiments of the present disclosure.

### DETAILED DESCRIPTION

For the purpose of the present description and of the appended claims, except where otherwise indicated, all numbers expressing amounts, quantities, percentages, and so forth, are to be understood as being modified in all instances by the term “about”. Also, all ranges include any combination of the maximum and minimum points disclosed and include any intermediate ranges therein, which may or may not be specifically enumerated herein.

For the purpose of the present description and of the appended claims, the words “a” or “an” should be read to include one or at least one and the singular also includes the plural unless it is obvious that it is meant otherwise. This is done merely for convenience and to give a general sense of the disclosure.

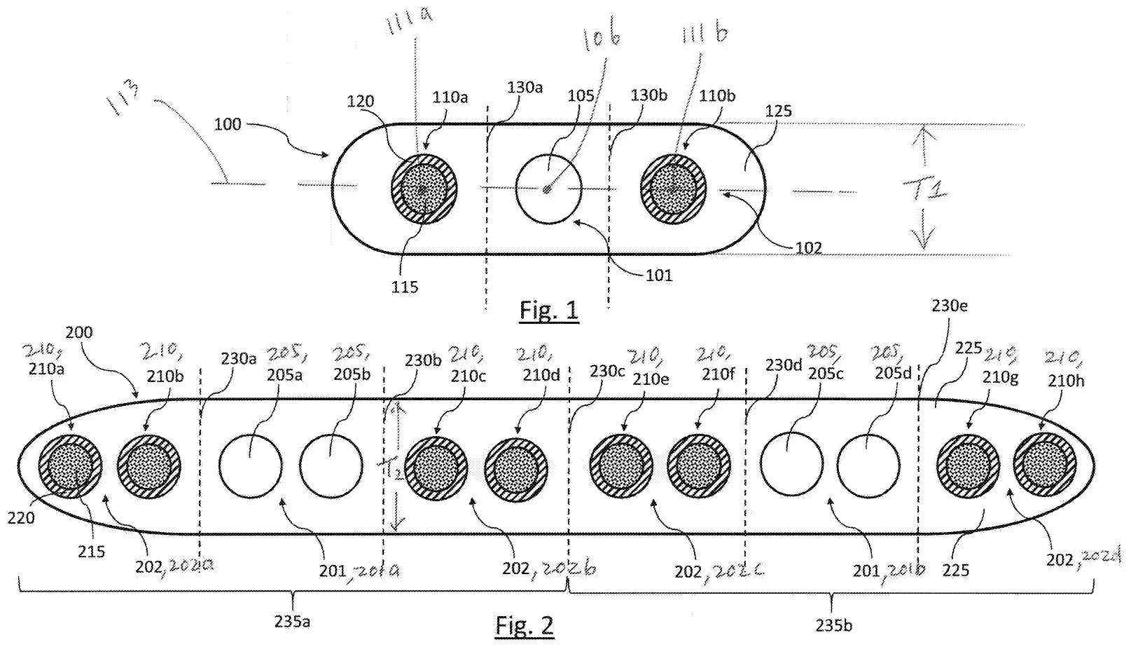

FIG. 1 schematically depicts a cable 100 according to some embodiments of the present disclosure. The cable 100 is a ribbon cable. The cable 100 contains a telecommunication section 101 comprising one optical fiber 105, and two electric sections 102 each comprising a bundle of carbon nanotube yarns 110a and 110b. The number of optical fibers and the number of bundles of carbon nanotube yarns contained in the cable according to the present disclosure is not limitative: a cable according to the present disclosure might contain more than one optical fiber and more than two bundles of carbon nanotube yarns.

In the illustrative example of FIG. 1, the optical fiber 105 and the two bundles of carbon nanotube yarns 110a and 110b, or more precisely, their longitudinal axes 106, 111a, 111b, lay substantially on a same plane 113 with the cable in an un-twisted condition. This arrangement helps in keeping the cable 100 flat, of reduced thickness.

In the illustrative example of FIG. 1 the optical fiber 105 is arranged in between the bundles of two carbon nanotube yarns 110a and 110b. This arrangement ensures a suitable separation (electric insulation) between the two bundles 110a and 110b.

In some embodiments, the optical fiber 105 is equidistant from the two bundles 110a and 110b. For example, the optical fiber 105 is spaced apart from the two bundles 110a, 110b with substantially a same distance, respectively.

In some embodiments, the optical fiber 105 is a single-mode optical fiber or a multi-mode optical fiber. In some embodiments, the optical fiber has a glass core surrounded by a glass cladding and one or more coating layers surrounding the glass cladding. In some embodiments, the optical fiber has an outer diameter of 245 ±10

In some embodiments, each bundle 110a and 110b comprises a group of carbon nanotube yarns 115 surrounded by a coating layer 120. The two bundles 110a and 110b have equal outer diameters. The outer diameters of the two bundles 110a and 110b are equal to, substantially equal to or similar to the outer diameter of the optical fiber 105. For example, the outer diameters of the two bundles 110a and 110b are of 250 μm. Each bundle 110a, 110b can transport up to 5•10⁻² A of electrical current at 70° C.

The optical fiber 105 and the two bundles 110a and 110b are embedded in a matrix 125. The thickness T1 of the cable 100 is in a range about 300-350 μm.

In use, the optical fiber 105 may serve for transmission of signals. In use, the two bundles of carbon nanotube yarns 110a and 110b may serve as strengthening members for the cable 100 and may serve for electrical energy or data delivery. As electric conductors, one of the bundles 110a and 110b is at a first electrical potential while the other one of the bundles 110a and 110b is at a second electrical potential that is different from the first electrical potential. For example, the first electrical potential can be a positive electrical potential, e.g., with respect to a reference potential, and the second electrical potential can be a negative electrical potential, e.g., with respect to the reference potential. The arrangement of the optical fiber 105 in between the two bundles 110a and 110b ensures a suitable electrical insulation between the two bundles of carbon nanotube yarns 110a and 110b, substantially reducing or even removing the risk of electrical shorts.

In use, during installation of the cable 100, the cable 100 can be at least partially torn apart along one or both of two separation lines 130a and 130b, for example, for purposes of splicing the optical fiber 105, and/or for interconnection of the bundles 110a and 110b to electronic devices.

FIG. 2 schematically depicts a cable 200 according to some embodiments of the present disclosure. In the embodiments of FIG. 2 the cable 200 contains a plurality of optical fibers and a plurality of more than two carbon nanotube yarns. The cable 200 contains two telecommunication sections 201 (201a, 201b), each comprising a pair of optical fibers amounting to four optical fibers 205a-205d in the cable, and four electric sections 202 (202a-202d), each comprising two bundles of carbon nanotube yarns 210 amounting to eight bundles 210a-210h in the cable.

Similar to the example embodiments of FIG. 1, also in the example cable 200 of FIG. 2 the four optical fibers 205a-205d and the eight bundles of carbon nanotube yarns 210a-210h, or more precisely, their respective longitudinal axes, lay substantially on a same plane, with the cable in an un-twisted condition. This arrangement helps in keeping the cable 200 flat, at reduced thickness.

The two optical fibers 205a and 205b, or 205c and 205d in each telecommunication section 201a or 201b are arranged adjacent to one another. The two bundles 210 (210a and 210b, 210c and 210d, 210e and 210f, or 210g and 210h) in each electric section 202 (202a, 202b, 202c, 202d) are arranged adjacent to one another. In the example embodiments of FIG. 2, each optical fiber pair is arranged in between two adjacent pairs of bundle of carbon nanotube yarns. This arrangement ensures a suitable electric insulation between the carbon nanotube yarns.

In some embodiments, the optical fibers 205a-205d and the bundles 210a-210h are all equidistant. For example, each optical fiber 205 is spaced apart from an adjacent bundle 210 by a substantially same distance. Each optical fiber 205 is spaced apart from an adjacent optical fiber 205 by a substantially same distance. Each bundle 210 is spaced apart from an adjacent bundle 210 by a substantially same distance. A distance between two adjacent optical fibers 205 is equal to, substantially equal to or similar to a distance between two adjacent bundles 210.

The optical fibers 205a-205d can be single-mode optical fibers or multi-mode optical fibers. The optical fibers 205a-205d each have an outer diameter in a range of 235-255 μm.

Similar to the embodiment of FIG. 1, each bundle 210a-210h comprises a group of carbon nanotube yarns 215 surrounded by a coating layer 220. In some embodiments, the bundles 210a-210h all have equal outer diameter. The outer diameters of the bundles 210a-210h are equal to, substantially equal to or similar to the outer diameters of the optical fibers 205a-205d. For example, the outer diameters of the carbon nanotube yarns 210a-210h are 250 μm.

The optical fibers 205a-205d and the bundles 210a-210h are embedded in a matrix 225. In some embodiments, the thickness T2 of the cable 200 is in a range of about 300-350 μm. The cable 200 as a whole can be divided into two components: a first component 235a and a second component 235b. The first component 235a includes a telecommunication section 201a and two electrical sections 202a, 202b. Specifically, from left to right in FIG. 2, the first component 235a includes the bundles 210a and 210b, the optical fibers 205a and 205b and the bundles 210c and 210d. The second component 235b includes a telecommunication section 201b and two electrical sections 202c, 202d.

Specifically, from left to right in FIG. 2, the second component 235b includes the bundles 210e and 210f, the optical fibers 205c and 205d and the bundles 210g and 210h.

In use, during installation of the cable 200, the cable 200 can be at least partially torn apart along one or more of five separation lines 230a-230e, for example for purposes of splicing the optical fibers 205a-205d and/or for interconnection of the carbon nanotube yarns 210a-210h to electronic devices.

In the examples of FIGS. 1 and 2, each telecommunication section 101, 201 is arranged in the matrix 125, 225 in between two respective electric sections 102, 202. Accordingly, the cable comprises an even number of electric sections.

In some embodiments, the carbon nanotubes in the yarns 115, 215 are of the single-wall type “SWNTs” or of the few-wall type “FWNTs”.

Some embodiments of a process for producing a cable according to the present disclosure comprise the following steps.

A group of carbon nanotube yarns is covered with a layer of a radiation curable material, such as an acrylate to form a coating layer. For example, the coating layer has a thickness of 5-10 μm. For example, the radiation curable material can have a viscosity of 4000-6000 Cps. Once cured, the material of the coating layer can have a modulus of 50-100 MPa. Once cured, the material of the coating layer can have an elongation at break of 100-120%.

The group of carbon nanotube yarns covered by the layer of radiation curable material is submitted to a curing step to obtain a bundle of carbon nanotube yarns with a coating layer. For example, in the curing step the curable material of the layer is cured to 92-97%.

A selected number of optical fibers and of bundles of carbon nanotube yarns (previously submitted to curing) is passed in a ribbon guide at 40-50° C. for embedding them in a radiation curable material. For example, the radiation curable matrix can have a viscosity of 2000-5000 CpS at said temperature. When passing the selected number of optical fibers and of bundles in the ribbon guide, the optical fibers and the bundles are positioned to obtain the desired arrangement of optical fibers and bundles in the cable, e.g., the arrangement of FIG. 1 or FIG. 2.

The radiation curable material with optical fibers and bundles of carbon nanotube yarns embedded therein is then cured.

The cable according to the present disclosure is advantageous because being a ribbon it is relatively flat, a property that makes the cable particularly suitable for installations where the space is limited. For example, in the automotive field, the ribbon cable can be easily routed through a vehicle under the upholstery. For example, the cable according to the present disclosure can be expediently used for interconnecting electronic apparatuses located at the front and at the back of a vehicle. The optical fiber(s) in the cable allows a fast exchange of large amounts of data (and does not suffer from electromagnetic fields, contrary to metal signal lines) while at the same time delivering electric power, e.g., for supplying the apparatuses located at the back of the vehicle.

The carbon nanotube yarns in the cable allow a suitable electrical current transport. Despite this, the electrical conductivity of carbon nanotube yarns is presently not yet as high as the electrical conductivity of some metal electrical conductors, like copper electrical conductors (the specific electrical conductivity of carbon nanotube yarns can reach 19,000 S•cm²/g), there are several applications (e.g., in the automotive field) in which it is not necessary to deliver high electric power and the electrical conductivity of carbon nanotube yarns is more than sufficient. At the same time, the carbon nanotube yarns act as tensile strength members for the ribbon cable, too. Particularly, the carbon nanotube yarns make the ribbon cable more resistant to tensile stresses. With respect to a copper electrical conductor, the carbon nanotube yarns make the ribbon more flexible. Moreover, carbon nanotube yarns are lighter than metal, e.g., copper conductors, thus allowing a reduction in weight of the cable. Another advantage of carbon nanotube yarns over metal, e.g., copper conductors, is that the carbon nanotube yarns can be used as they are, without any electrical insulation.

The cable according to the present disclosure is also advantageous because the same, or quite similar, manufacturing apparatuses and installation (e.g., optical fiber splicing) tools can be re-used as those are normally exploited for purely optical ribbon cables.

As mentioned in the foregoing, the number of optical fibers and the number of carbon nanotube yarns contained in the cable according to the present disclosure is not limitative, and the examples presented in connection with FIGS. 1 and 2 are merely illustrative. Irrespective of the number of optical fibers and bundles of carbon nanotube yarns contained in the cable, a possible arrangement can be having groups of one or more bundles of carbon nanotube yarns on both sides of a group of one or more optical fibers.

The various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A cable, comprising:
a telecommunication section including at least one optical fiber;
at least two electric sections each including at least one bundle of carbon nanotube yarns; and
a matrix encapsulating the telecommunication section and the at least two electric sections,
wherein the telecommunication section is arranged in the matrix between two electric sections of the at least two electric sections, and the optical fiber and bundles of carbon nanotube yarns are positioned at substantially a same level to form a ribbon.

2. The cable of claim 1, wherein the telecommunication section includes two optical fibers.

3. The cable of claim 1 comprising at least two telecommunication sections.

4. The cable of claim 1, wherein each electric section includes two bundles of carbon nanotube yarns.

5. The cable of claim 1, wherein each telecommunication section is arranged in the matrix between two respective electric sections so that the cable comprises an even number of electric sections.

6. The cable of claim 1, wherein each electric section is configured to carry a positive or a negative electric potential only.

7. The cable of claim 1, wherein each optical fiber and each bundle of carbon nanotube yarns have outer diameters substantially similar to one another.

8. The cable of claim 1, wherein each bundle of carbon nanotube yarns includes a group of carbon nanotube yarns covered by a coating layer.

9. The cable of claim 8, wherein the coating layer has a thickness in a range of about 5-10 μm.

10. The cable of claim 1, wherein the carbon nanotubes in the yarns are of a single-wall type “SWNT” or of a few-wall type “FWNT”.

11. A process for producing a cable, comprising:
providing at least one optical fiber;
providing at least two groups of carbon nanotube yarns;
providing each group of carbon nanotube yarns with a respective coating layer to form a bundle; and
embedding in a matrix the at least one optical fiber and at least two bundles of carbon nanotube yarns, a telecommunication section being arranged between two bundles of carbon nanotube yarns of the at least two bundles of carbon nanotube yarns at substantially a same level to form a ribbon.
